(19) United States
(12) Patent Application Publication
(10) Pub. No.: US 2026/0086602 A1
(43) Pub. Date: Mar. 26, 2026

(54) ELECTRONIC DEVICE DISPLAY CURTAIN

(71) Applicant: Apple Inc., Cupertino, CA (US)

(72) Inventors: Thineshan Kathirchelvan, San Jose, CA (US); Di Lu, San Jose, CA (US); Hiroshi Kubo, Santa Clara, CA (US)

(21) Appl. No.: 19/056,858

(22) Filed: Feb. 19, 2025

Related U.S. Application Data
(60) Provisional application No. 63/697,330, filed on Sep. 20, 2024.

(51) Int. Cl. G06F 1/16; G02B 7/02

(52) U.S. Cl. CPC G06F 1/163; G02B 7/023

(57) ABSTRACT

A head mountable display device includes a frame, a lens movably coupled to the frame, and a curtain assembly extending between the frame and the lens. The curtain assembly includes a first fabric layer having a first surface area and defining an external surface and a second fabric layer having a second surface area greater than the first surface area.

### CROSS-REFERENCE TO RELATED APPLICATIONS

This claims priority to U.S. Provisional Patent Application No. 63/697,330 , filed 20 Sep. 2024, and entitled “ELECTRONIC DEVICE DISPLAY CURTAIN,” the entire disclosure of which is hereby incorporated by reference.

### FIELD

The described embodiments relate generally to wearable electronic devices. More particularly, the present embodiments relate to head-mountable display devices and components thereof.

### BACKGROUND

Recent advances in portable computing have led to a surge in head-mountable display devices. These devices offer a wide range of applications, from entertainment and gaming to augmented reality experiences that enhance the user's physical environment. Heat-producing electronic components of the device can be cooled using fans circulating air. Because head-mountable display devices interact in close proximity to the user's face to project images toward the eyes, what is needed in the art are display and cooling systems for head-mountable devices that reduce uncomfortable or noisy aspects of airflow and cooling systems at such close ranges.

### SUMMARY

In at least one example of the present disclosure, a head mountable display device includes a frame, a lens movably coupled to the frame, and a curtain assembly extending between the frame and the lens. The curtain assembly includes a first fabric layer having a first surface area and defining an external surface and a second fabric layer having a second surface area greater than the first surface area.

In one example, the curtain assembly includes a first edge coupled to the frame and a second edge coupled to the lens and the first fabric layer and the second fabric layer are free of affixation to one another between the first edge and the second edge. In one example, the first fabric layer and the second fabric layer are coupled together at the first edge and at the second edge. In one example, the second fabric layer is thinner than the first fabric layer. In one example, the first fabric layer includes a first woven material, and the second fabric layer includes a second woven material different than the first woven material. In one example, the second fabric layer includes a lower thread count than the first fabric layer. In one example, the first fabric layer is configured to remain taut when the lens is in, or is moved to, each position of a plurality of positions relative to the frame. In one example, the second fabric layer is configured to remain slack when the lens is in, or is moved to, any position of a plurality of positions relative to the frame. In one example, the device further includes an optical assembly including the lens and a display.

In at least one example of the present disclosure, a display device includes a frame defining an aperture, a lens disposed in the aperture, and a curtain assembly coupled between the frame and the lens. The curtain assembly includes a taut layer occluding the aperture between the lens and the frame and defining an external surface and a slack fabric layer extending between the lens and the frame.

In one example, the lens is a first lens, the display device further includes a second lens, and the curtain assembly includes a middle portion extending between the first lens and the second lens and a side portion extending between the first lens and the frame, the first lens disposed between the middle portion and the side portion. In one example, the taut layer includes a woven fabric. In one example, the display device further includes a motor coupled to the lens. In one example, the frame defines an internal volume, the display device further includes an optical assembly disposed in the internal volume, the optical assembly including the optical lens and a display screen, and the motor is configured to adjust a position of the lens relative to the frame. In one example, the taut layer extends between the lens and the frame in tension.

In at least one example of the present disclosure, a wearable electronic display device includes a frame, an optical lens adjustably coupled to the frame, and a curtain assembly coupled between the frame and the optical lens. The curtain assembly includes a first layer extending between the frame and the optical lens in tension, the first layer having a first surface area and a second layer extending between the frame and the optical lens, the second layer having a second surface area greater than the first surface area.

In one example, the frame defines an aperture, and the wearable electronic display device further includes an optical assembly disposed in the aperture. The optical assembly includes the optical lens and a display screen. In one example, the curtain assembly occludes the aperture between the optical lens and the frame. In one example, the first layer includes a first woven fabric, and the second layer includes a second woven fabric. In one example, the curtain assembly includes a perimeter edge coupled to the frame, the curtain assembly includes an inner edge coupled to the optical lens, and the first layer and the second layer are free of affixation to one another between the perimeter edge and the inner edge.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A shows a rear perspective view of an example of a head mountable device;

FIG. 1B shows an exploded view of the device shown in FIG. 1A;

FIG. 2 shows a rear, upper, perspective view of an example of a head mountable device;

FIG. 3 shows a rear, lower, perspective view of an example of a head mountable device;

FIG. 4 shows a side, cross-sectional view of an example of a head mountable display device;

FIG. 5 shows a plan view of an example of a curtain assembly of a head mountable display device;

FIG. 6 shows a top, cross-sectional view of a portion of an example of a head mountable display device;

FIG. 7A shows a top, cross-sectional view of a portion of an example of a head mountable display device with a display module in a first position;

FIG. 7B shows a top, cross-sectional view of a portion of an example of a head mountable display device with the display module in a second position;

FIG. 8A shows a front perspective view of an example of a curtain assembly of a head mountable display device; and

FIG. 8B shows a rear perspective view of an example of a curtain assembly of a head mountable display device.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates general to wearable electronic devices. More particularly, the present disclosure relates to head mountable display devices and components thereof. Head mountable display devices include heat-producing electronic components, such as displays, processors, and so forth, which can be cooled using fans or blowers circulating air through the device. Because head-mountable display devices interact in close proximity to the user's face to project images toward the eyes, display and cooling systems of current devices can generate uncomfortable airflow to the user's eyes. Also, noise from the various components, including blowers, fans, and other moving components, can be distracting during use. In order to reduce or remove airflow to the user's eyes, as well as reduce noise associated with various components, the head mountable display devices of the present disclosure include display curtain assemblies.

The curtain assembly of the head mountable display devices described herein can include one or more fabric layers extending between a frame of the device and one or more optical modules of the device, including display screens, lenses, and so forth. The curtain assembly can extend across, and occlude, a viewing aperture of the frame between the frame and the optical module(s). This curtain assembly can prevent or reduce airflow generated by internal fans from exiting the viewing aperture and reaching the user's eyes, airflow entering between the user's face and the facial interface, or other airflow pathways in any direction. In addition, the curtain assembly can be made of quiet materials, such as woven fabrics and the like, to reduce noise as various portions of the curtain assembly are stretched or contracted.

Portions of the curtain assembly can be stretched or contracted between the frame and the optical modules as the optical modules are moved relative to the frame during use, for example to adjust display positions to match the user's specific interpupillary distance. The curtain assembly can include two layers, an outer layer and an inner layer, which are not fixed to one another save at a perimeter edge attached to the frame and at an inner edge attached to the optical module(s). The outer layer can remain in tension regardless of the position of the optical module(s) such that the outer layer remains smooth and aesthetically pleasing from a viewpoint external to the device. The inner layer of the curtain assembly can have a greater surface area than the outer layer such that the inner layer remains slack and unstretched regardless of the position of the optical module(s). In this way, the inner layer does not provide any back force on the motors moving the optical module(s) and keeping them in place. The slack inner layer also reduces air-permeability of the fabric, as opposed to higher permeability of a stretched fabric.

In addition, both layers of the curtain assembly can be made of woven fabric materials. In this way, the layers, which may rub or contact one another during movement of the optical module(s) and use of the device, do not make noticeable or irritating noise while doing so. Thus, the curtain can block airflow to the user's eyes while remaining aesthetically pleasing and silent during adjustments and use.

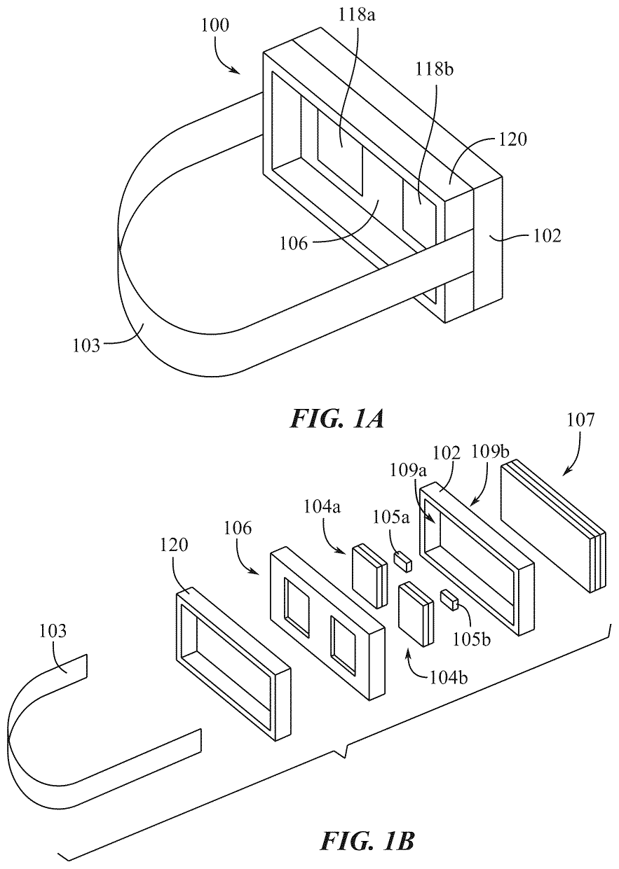

These and other embodiments are discussed below with reference to FIG. 1A-8B. However, those skilled in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIGS. 1A and 1B illustrate a perspective view and an exploded view, respectively, of an example of a head-mountable device (HMD) 100 including a frame 102 and first and second optical modules 104a, 104b, including respective lenses 118a-b, configured to be coupled to the frame 102. In at least one example, the frame 102 defines a rearward facing viewing aperture 109a through which the user donning the HMD 100 can view light projected from display screens of the optical module 104a-b. The frame 102 of the HMD 100 can define first (rearward) and second (forward) opposing apertures 109a, 109b. In at least one example, a forward facing display assembly 107 can be disposed in the second (forward) aperture 109b. The forward facing display assembly 107 can include a number of components and layers, including display screens, films, and a transparent cover defining an external surface of the device 100. The forward facing display assembly 107 can be configured to direct light outward from the device to others, for example in a direction opposite a direction of light projection of the first and second optical modules 104a-b toward the user.

In at least one example, the optical modules 104a-b can include optical components and assemblies such as display screens, lenses, and so forth. The HMD 100 can also include a curtain assembly 106 coupled to the frame 102 and extending across the first aperture 109a between the frame 102 and the optical modules 104a-b, for example between the frame 102 and the lenses 118a-b of the optical modules 104a-b. In this way, the curtain assembly 106 occludes the aperture 109a between the lenses 118a-b and the frame 102. The curtain assembly 106 can include multiple components, parts, and layers, to manage airflow through the HMD 100 due to cooling systems having fans blowing air through an internal volume of the HMD 100.

In at least one example, the HMD 100 can include motors 105a, 105b for moving respective optical modules 104a-b relative to the frame 102. The motors 105a-b can be configured to automatically and electrically adjust a distance between the first and second optical modules 104a-b, including a distance between the first and second lenses 118a-b, to accommodate and match an interpupillary distance of the user. In this way, the optical modules 104a-b and lenses 118a-b thereof are movable relative to other components of the HMD 100, including relative to the frame 102. Examples described herein include motors 105a-b configured to move optical modules 104a-b, however these examples are non-limiting. Other examples can include devices without motors. In such examples, the optical modules 105a-b can be manually moved, adjusted, and manipulated either directly or through various manual knobs, buttons, dials, gears, and so forth. The presence and functionality of the curtain assembly 106 described herein can be the same for devices with automated adjustments using motors 105a-b or manual adjustments without any motors.

The HMD 100 can also include a facial interface 120 coupled to and/or extending from the frame 102 to contact the user's face around the user's eyes when donning the HMD 100. The facial interface 120 can be configured to conform to a shape of the user's face to provide comfort. The facial interface 120 can define a distance between the user's eyes and the lenses 118a-b when the HMD 100 is donned. The HMD 100 can also include a securement strap or band 103 coupled to the HMD 100, for example coupled to the frame 102 or the interface 120 and configured to secure the HMD 100 to the user's head. The band 103 can be configured to wrap around a user's head. Other examples of bands or device securement components can include straps, arms, and so forth.

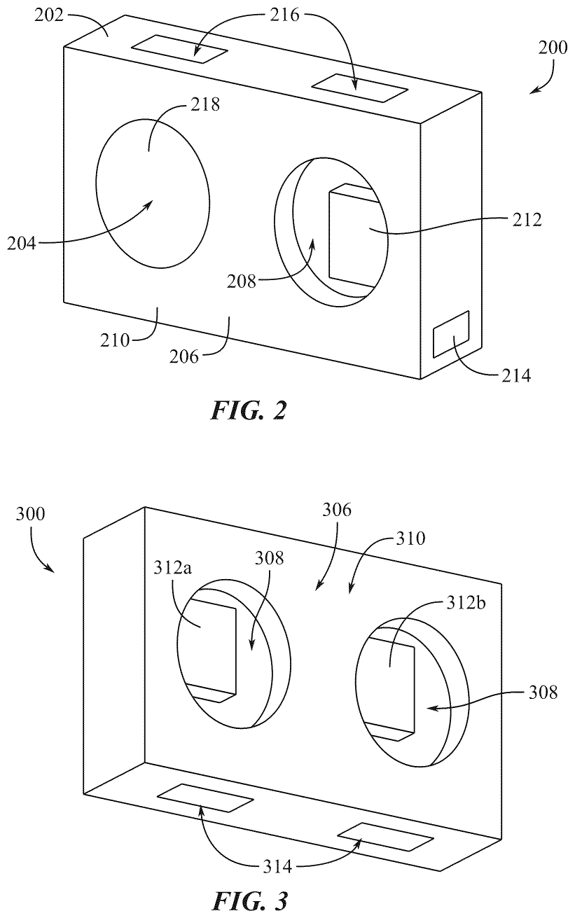

Any of the features, components, and/or parts, including the arrangements and configurations thereof shown in FIGS. 1A and 1B can be included, either alone or in any combination, in any of the other examples of devices, features, components, and parts shown in FIG. 2-8B and described herein. Likewise, any of the features, components, and/or parts, including the arrangements and configurations thereof shown and described with reference to FIG. 2-8B can be included, either alone or in any combination, in the example of the devices, features, components, and parts shown in FIGS. 1A and 1B.

FIG. 2 shows a rear, top, perspective view of an HMD 200 including a frame 202 defining an external surface of the device, an internal volume 208, and a rear-facing viewing opening 210, which can also be referred to as an aperture or viewing aperture. The HMD 200 also includes an optical module 204 including a lens 218 through which the user can view the light projected from a display screen of the optical module 204 disposed in the internal volume 208. In at least one example, the HMD 200 also includes a curtain assembly 206 occluding the viewing opening 210 between the lens 218 and the frame 202.

In at least one example, the HMD 200 can include one or more motors mechanically coupled to the optical module 204 to alter a position of the optical module 204, including the lens 218, relative to the frame 202. These motors can be used to adjust the optical module(s) 204 of the HMD 200 to match the interpupillary distance defined by the user's eyes. In at least one example, the curtain assembly 206 can be elastically deformable or stretchy to accommodate the different possible positions of the optical module 204, including the lens 218, such that the curtain assembly occludes the viewing aperture/opening 210 between the frame 202 and the optical module(s) 204 or lens(es) 218 thereof regardless of the position or movement of the optical module 204 and lens 218. As noted above, other examples can offer manual adjustments of the optical module(s) 204 without motors, for example using gear trains, ungeared systems, or other adjustment mechanisms.

The HMD 200 shown in FIG. 2 includes a first optical module 204 configured to align with a user's left eye but does not show a second optical module configured to align with a user's right eye so that the internal volume 208 and fan 212 can be seen. The HMD 200 can include one or more fans 212 in the internal volume. The HMD 200 can include a second fan, not seen, aligned with the optical module 204 shown. The frame 202 can define one or more intake ports 214 and one or more exhaust ports 216 on an opposing side of the frame 202 relative to the intake ports 214. The fan 212 can be configured to draw air into the internal volume 208 through the intake ports 214 and exhaust the air from the internal volume 208 out through the exhaust ports 216.

The fan 212 can be configured to draw air in and out of the internal volume 208 to cool various heat-generating components within the HMD 200. Such components can include processors, display screens of the optical module(s) 204, sensors, and so forth. In such an example, the curtain assembly 206 can be configured to prevent the flow of air from reaching the user's eyes when donning the HMD 200 such that the airflow through the HMD 200 does not dry the eyes out and cause discomfort.

Accordingly, in order to serve the dual purpose of preventing airflow from reaching the user's eyes and maintaining an elastic, aesthetically pleasing barrier occluding the viewing aperture/opening 210, the curtain assembly 206 can include a first layer defining an external surface of the HMD 200 and a second layer defining the internal volume 208. In one example, the second layer can be semi-elastic, or have some elasticity, but remain sufficiently air-impermeable when stretched or deformed.

Any of the features, components, and/or parts, including the arrangements and configurations thereof shown in FIG. 2 can be included, either alone or in any combination, in any of the other examples of devices, features, components, and parts shown in FIGS. 1A-1B and 3-8B and described herein. Likewise, any of the features, components, and/or parts, including the arrangements and configurations thereof shown and described with reference to FIGS. 1A-1B and 3-8B can be included, either alone or in any combination, in the example of the devices, features, components, and parts shown in FIG. 2.

FIG. 3 shows a rear, lower perspective view of an example of an HMD 300 similar to the HMD 200 shown in FIG. 2, including a frame 302 defining an internal volume 308, viewing opening 310, intake port(s) 314, and exhaust port(s) 316. The HMD 300 can also include first and second fans 312a, 312b disposed in the internal volume 308 and drawing air through the internal volume 308 via the intake ports 314 and exhaust ports. FIG. 3 does not include optical modules in order to visualize the internal volume 308 and fans 312a-b aligned with the apertures and optical module positions. The HMD 300 can also include a curtain assembly 306 similar to the curtain assembly 206 illustrated in FIG. 2, where the curtain assembly 306 occludes the viewing opening 310 between the frame 302 and the optical modules.

Any of the features, components, and/or parts, including the arrangements and configurations thereof shown in FIG. 3 can be included, either alone or in any combination, in any of the other examples of devices, features, components, and parts shown in FIGS. 1A-2 and 4-8B and described herein. Likewise, any of the features, components, and/or parts, including the arrangements and configurations thereof shown and described with reference to FIGS. 1A-2 and 4-8B can be included, either alone or in any combination, in the example of the devices, features, components, and parts shown in FIG. 3.

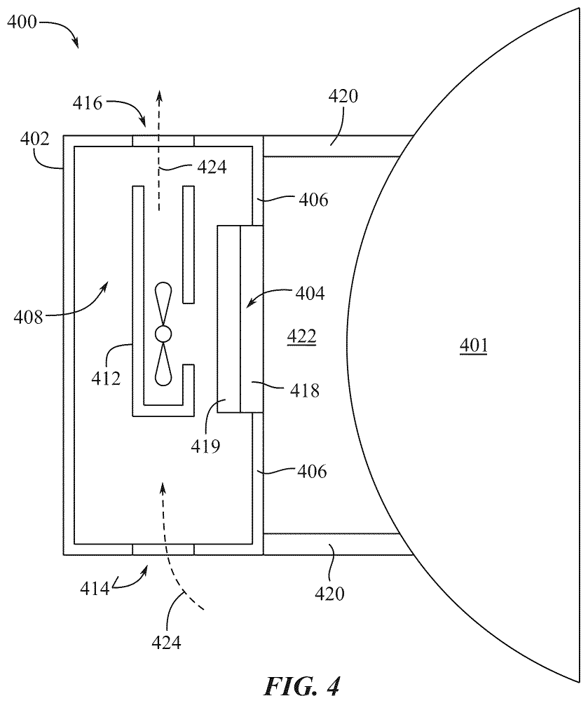

FIG. 4 illustrates a side, cross-sectional view of an example of and HMD 400 donned by a user 401. The HMD 400 can include a frame, also referred to as a housing 402, defining an internal volume 408 and a fan assembly 412 disposed in the internal volume 408. The housing 402 can define an intake port 414 and an exhaust port 416 and the fan assembly 412 can be configured to draw air 424 through the intake port 414 into the internal volume and push the air 424 out from the internal volume 408 through the exhaust port 416.

In at least one example, the HMD 400 can include an optical module 404, including a lens 418 and a display 419 (e.g., a display screen) configured to direct light toward the user's eye through the lens 418, and a light seal 420 extending around a perimeter of the HMD 400 between the housing 402 and the user's face when the user 401 dons the HMD 400 as shown. In at least one example, the HMD 400 also includes a curtain assembly 406 extending between the housing 402 and the optical module 404. The curtain assembly 406 can be configured to block the air 424 from entering a space 422 between the eyes/face of the user 401, the space being defined by the user 401, the light seal 420, the optical module 404, and the curtain assembly 406.

Any of the features, components, and/or parts, including the arrangements and configurations thereof shown in FIG. 4 can be included, either alone or in any combination, in any of the other examples of devices, features, components, and parts shown in FIGS. 1A-3 and 5-8B and described herein. Likewise, any of the features, components, and/or parts, including the arrangements and configurations thereof shown and described with reference to FIGS. 1A-3 and 5-8B can be included, either alone or in any combination, in the example of the devices, features, components, and parts shown in FIG. 4.

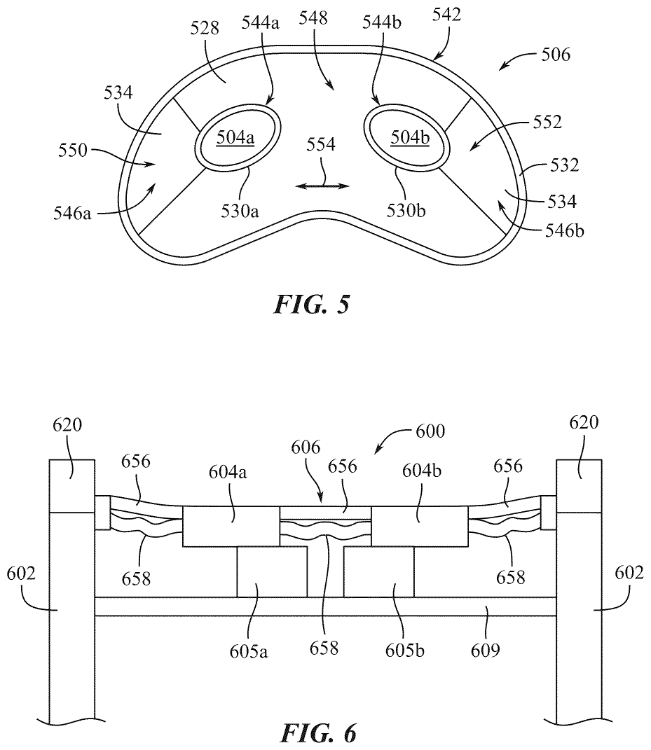

FIG. 5 illustrates a plan view of an example of a curtain assembly 506 including first and second layers 534, 528, respectively, coupled to a frame or backplate 532 at an outer perimeter edge 542 and extending to inner edges 544a, 544b coupled to trim rings 530a, 530b and/or optical modules 504a, 504b, respectively. In at least one example, the first layer can extend to cover substantially all of an area between the backplate 532 and trim rings 544a-b coupling the layers 534, 528 to the optical modules 504a-b. In the plan view of FIG. 5, the second layer 528 overlies the first layer 534 such that much of the first layer 534 is not visible. However, as noted above, the first layer 534 can occlude substantially all of the aperture/opening between the lenses of the optical modules 504a-b and the frame or backplate 532.

In at least one example, the second layer 528 can extend between the frame or backplate 532 and the lenses of the optical modules 504a-b and/or the trim rings 530a-b to define laterally positioned gaps 546a and 546b where the second layer 528 does not extend between the frame/backplate 532 and the lenses/optical modules 504a-b. In at least one example, the second layer 528 covers between about 70% and about 90% of the area between the frame/backplate 532 and the optical modules 504a-b/trim rings 530a-b. In some examples, the second layer 528 covers between about 75% and about 90% of the area, for examples between about 80% and about 85% of the area. The gaps 546a and 546b can also allow for some airflow through the curtain assembly 506 and to the user's eyes, which can keep the face and eye area of the user cool as well as provide de-fogging airflow for the screens of the displays and lenses of the HMD.

The curtain assembly 506 can define a middle portion 548 extending between the first lens or optical module 504a and the second lens or optical module 504b. The curtain assembly 506 can also define a first side portion 550 extending between the first lens or optical module 504a and the frame/backplate 532 and a second side portion 552 extending between the second lens or optical module 504b and the frame/backplate 532. In such an example, the gaps 546a-b can be disposed or positioned at the first and second side portions 550, 552, respectively. As such, as the lenses/optical modules 504a-b are moved laterally back and forth in the direction indicated by arrows 554, the absence of material of the second layer 528 at the gaps 546a-b can reduce forces opposing the static positioning of the optical modules 504a-b and/or opposing the forces of motors configured to move the optical modules 504a-b relative to the frame/backplate 532, as described above.

Any of the features, components, and/or parts, including the arrangements and configurations thereof shown in FIG. 5 can be included, either alone or in any combination, in any of the other examples of devices, features, components, and parts shown in FIGS. 1-4 and 6-8B and described herein. Likewise, any of the features, components, and/or parts, including the arrangements and configurations thereof shown and described with reference to FIGS. 1-4 and 6-8B can be included, either alone or in any combination, in the example of the devices, features, components, and parts shown in FIG. 5.

FIG. 6 shows a partial cross-sectional view of a portion of an example of a head mountable display device 600, including a frame 602 and a facial interface 620 extending from the frame 602. In at least one example, the device 600 can include an internal frame 609 coupled to the frame 602 with first and second motors 605a, 605b mounted thereto. The motors 605a-b can movably couple respective optical modules 604a, 604b such that the optical modules 604a-b can be moved in position relative to the frame 602 or other components of the device 600. In this way, the optical modules 604a-b can be adjusted for matching or otherwise accommodating a user's interpupillary distance.

The device 600 can also include a curtain assembly 606 extending between the frame 602 and the optical modules 604a-b or assemblies. The curtain assembly 606 can include a first layer 656 extending between an outer edge of the curtain assembly 606 and the optical modules 604a-b to occlude the viewing aperture of the frame 602. The curtain assembly 606 can also include a second layer 658 extending between an outer edge of the assembly 606 and the optical modules 604a-b to occlude the viewing aperture of the frame 602. The first layer 656 can define an external surface of the device 600 facing the user's face and the second layer 658 can define an internal surface of the device 600 and be disposed inside the device 600. In at least one example, the curtain assembly 606 can be thus positioned to minimize or eliminate airflow from within the device 600 (e.g., cooling airflow from fans as noted above) from reaching the user's eyes.

In at least one example, the motors 605a-b are configured to move the positions of the optical modules 604a-b and the curtain assembly 606, including the first and second layers 656, 658, are configured to stretch, contract, and continue to occlude any opening or space between the optical assembly of the optical modules 604a-b and the frame 602 when the optical modules 604a-b are moved or moving. In order to reduce or eliminate airflow while reducing sounds associated with expanding and contracting layers 656, 658 of the curtain assembly 606, the first layer 656 can be a fabric layer, such as a woven fabric layer, and the second layer 658 can also be a fabric layer, such as a woven fabric layer.

In at least one example, the material of the second layer 658 is different than the material of the first layer 656. For example, the material of the first layer 656 can be a different thread count, thickness, or composition of one or more fibers than the material of the second layer 658. Because the first layer 656 is visible to the user, the material of the first layer 658 can be a higher thread count, smoother weave, and/or thicker to present a more visually pleasing material to the user. The second layer 658 disposed within the device 600 can include a lower thread count, be thinner, and/or be composed of less expensive and/or coarser woven materials.

In one example, the first layer 656 includes an air-permeable fabric layer and the second layer 658 includes an air-permeable fabric layer. The combination of the first and second layers 656, 658 together can create a boundary layer with sufficient air-impermeability, for example partial air-permeability, to reduce airflow from reaching the user's eyes at a noticeable or irritating extent. The minimal air-permeability can also provide a breathable material for reducing heat and sweat on the user's face around the eyes when donning the device 600. In one example, the second layer 658 can be more air-impermeable due to the slack nature of the second layer 658. The slack second layer 658 can also be configured to protect internal components of the device 600 from dust, sweat, chemical ingress, or other debris. In at least one example, the second layer 658 can be a non-fabric material, including one or more low noise polymers, films and the like.

The first layer 656 can have a first surface area defining an external surface of the device 600 and the second layer 658 can have a second surface area greater than the first surface area. As shown in FIG. 6, the greater surface area of the second fabric layer 658 can cause the second layer 658 to bunch up or otherwise crumple, wrinkle, fold, and/or crease such that the second layer 658 can be a slack fabric layer while the first fabric layer 656 can be a taut layer that remains smooth and taut between the optical modules 604a-b and the frame 602. As noted above, the second layer 658 can include a lower thread count, be thinner, and/or be composed of less expensive and/or coarser woven fabric materials. The material of the second layer 658 can be one that durably folds or wrinkles as shown while maintaining sufficient air-impermeability to reduce airflow to the user's eyes.

In the example shown in FIG. 6, the first layer 656 and the second layer 658 can include a perimeter edge coupled to the frame 602 and an inner edge coupled to the optical module 604a-b, such as to a lens of the optical module 604a-b. The first layer 656 and the second layer 658 can be free of affixation to each other between the edges. In one example, the layers 656, 658 are in contact with one another between the edges but still free of affixation to one another, at least between the edges. As the optical modules 604a-b are moved and the first and second layers 656, 658 are stretched and contracted in certain regions between the optical modules 604a-b and the frame 602, the sound of the layers 656, 658 rubbing together is minimized by the woven fabric materials of the layers 656, 658.

Any of the features, components, and/or parts, including the arrangements and configurations thereof shown in FIG. 6 can be included, either alone or in any combination, in any of the other examples of devices, features, components, and parts shown in FIGS. 1-5 and 7A-8B and described herein. Likewise, any of the features, components, and/or parts, including the arrangements and configurations thereof shown and described with reference to FIGS. 1-5 and 7A-8B can be included, either alone or in any combination, in the example of the devices, features, components, and parts shown in FIG. 6.

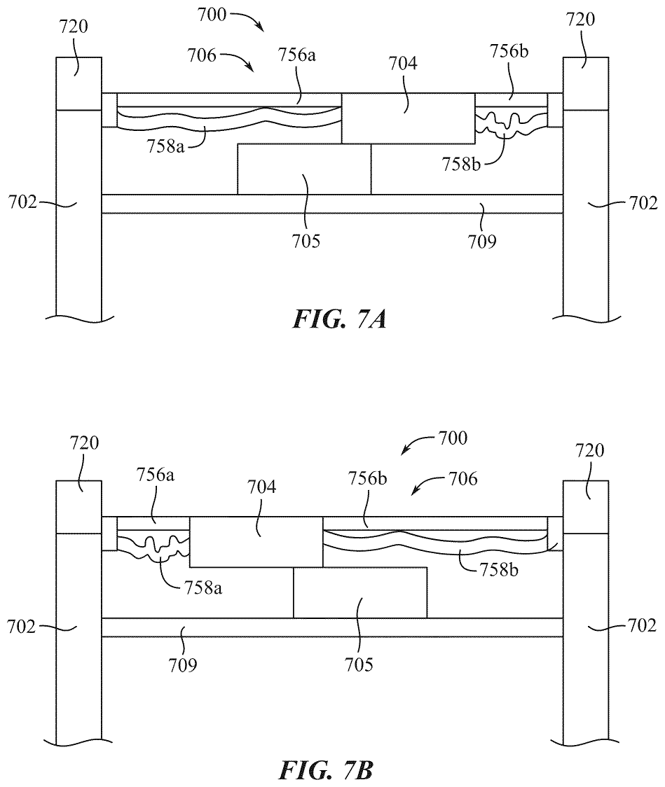

FIGS. 7A and 7B show a partial cross-sectional view of a portion of an example of a head mountable display device 700, including a frame 702 and a facial interface 720 extending from the frame 702, in inner frame 709 coupled to the frame 702, a motor 705 coupled to the inner frame 709, and an optical module 704 coupled to the motor 705. The device 700 can also include a curtain assembly 706 similar to other curtain assemblies discloses herein, for example similar to the curtain assembly 606 shown in FIG. 6 and described above. FIG. 7A shows the device 700 with the optical module 704 in a first position and FIG. 7B shows the device 700 with the optical module 704 in a second position.

In the first position shown in FIG. 7A, a first portion of the first layer 756a is taut, for example in tension, between the frame 702 and the optical module 704 and the second portion of the first layer 756b is also taut between the frame 702 and the optical module 704. Similarly, when the optical module is moved to the second position shown in FIG. 7B, a first portion of the first layer 756a is taut between the frame 702 and the optical module 704 and the second portion of the first layer 756b is also taut between the frame 702 and the optical module 704. Regardless of the position of the optical module 704, all portions of the first layer 756a-b remain taut and smooth. These portions of the first layer 756a-b are visible from outside the device 700 and thus remain aesthetically pleasing and smooth.

Also, in the first position shown in FIG. 7A, a first portion of the second layer 758a is slack, for example not in tension, between the frame 702 and the optical module 704 and the second portion of the second layer 758b is also slack between the frame 702 and the optical module 704. Similarly, when the optical module is moved to the second position shown in FIG. 7B, a first portion of the second layer 758a is slack between the frame 702 and the optical module 704 and the second portion of the second layer 758b is also slack between the frame 702 and the optical module 704. Regardless of the position of the optical module 704, all portions of the second layer 758a-b remain slack and wrinkled, folded, creased, and so forth. In this way, the second layer 758a-b does not exert any back forces on the motors 705 regardless of optical module 704 position.

Thus, as shown in FIGS. 7A and 7B, the first fabric layer 756a-b is configured to remain taut when the optical assembly module 704 is in, or is moved to, each position of a plurality of positions relative to the frame 702. The second fabric layer 758a-b is configured to remain slack when the optical assembly module 704 is in, or is moved to, any position of a plurality of positions relative to the frame 702.

Any of the features, components, and/or parts, including the arrangements and configurations thereof shown in FIGS. 7A and 7B can be included, either alone or in any combination, in any of the other examples of devices, features, components, and parts shown in FIGS. 1A-6 and 8A-8B and described herein. Likewise, any of the features, components, and/or parts, including the arrangements and configurations thereof shown and described with reference to FIGS. 1A-6 and 8A-8B can be included, either alone or in any combination, in the example of the devices, features, components, and parts shown in FIGS. 7A and 7B.

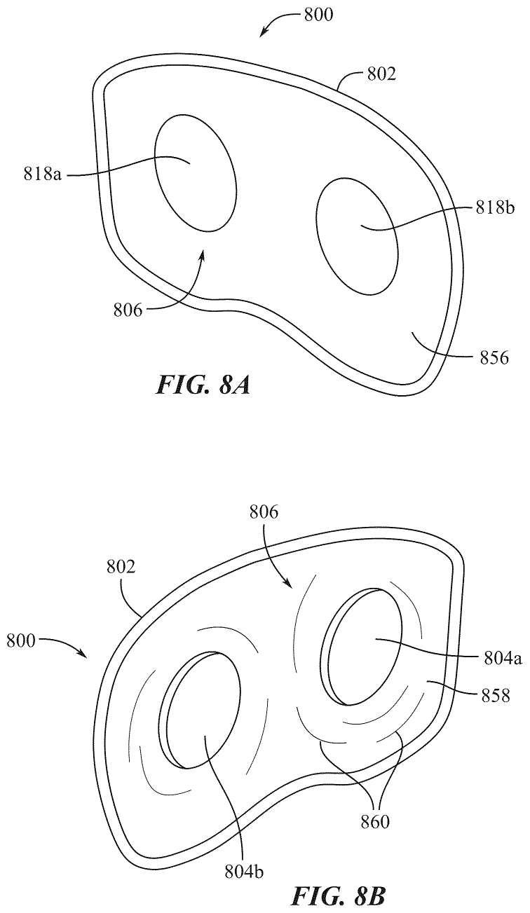

FIGS. 8A and 8B show front and rear perspective views, respectively, of a portion of a head mountable device 800, including a frame 802 and two optical module assemblies 804a, 804b, including respective lenses 818a, 818b, and a curtain assembly 806 extending between the frame 802 and the optical modules 804a-b and lenses 818a-b thereof. The front view of the device 800 shown in FIG. 8A shows a first layer 856 of the curtain assembly, which can be similar to the first layer 656, 756a-b, shown in FIGS. 6 and 7, respectively, and described in detail above. As shown, the first layer 856 can be taut and smooth in appearance.

The rear view of the device 800 shown in FIG. 8B shows a second layer 858 of the curtain assembly, which can be similar to the second layer 658, 758a-b, shown in FIGS. 6 and 7, respectively, and described in detail above. As shown, the second layer 856 can be slack and smooth and wrinkled, folded, creased, and so forth. The rear perspective view of IFG. 8B shows various creases or wrinkles 860.

Any of the features, components, and/or parts, including the arrangements and configurations thereof shown in FIGS. 8A and 8B can be included, either alone or in any combination, in any of the other examples of devices, features, components, and parts shown in FIG. 1A-7B and described herein. Likewise, any of the features, components, and/or parts, including the arrangements and configurations thereof shown and described with reference to FIG. 1A-7B can be included, either alone or in any combination, in the example of the devices, features, components, and parts shown in FIGS. 8A and 8B.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, X® (formerly TWITTER®) ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A head mountable display device, comprising:
a frame;
a lens movably connected to the frame; and
a curtain assembly extending between the frame and the lens, the curtain assembly comprising:
a first fabric layer having a first surface area and defining an external surface; and
a second fabric layer having a second surface area greater than the first surface area.

2. The head mountable display device of claim 1, wherein:
the curtain assembly includes a first edge coupled to the frame and a second edge coupled to the lens; and
the first fabric layer is free of affixation to the second fabric layer between the first edge and the second edge.

3. The head mountable display device of claim 2, wherein the first fabric layer is coupled to the second fabric layer at the first edge and at the second edge.

4. The head mountable display device of claim 1, wherein the second fabric layer is thinner than the first fabric layer.

5. The head mountable display device of claim 1, wherein:
the first fabric layer comprises a first woven material; and
the second fabric layer comprises a second woven material different than the first woven material.

6. The head mountable display device of claim 1, wherein the second fabric layer comprises a lower thread count than the first fabric layer.

7. The head mountable display device of claim 1, wherein the first fabric layer is configured to remain taut when the lens is in each position of a plurality of positions relative to the frame.

8. The head mountable display device of claim 7, wherein the second fabric layer is configured to remain slack when the lens is in any of the plurality of positions relative to the frame.

9. The head mountable display device of claim 1, further comprising an optical assembly including the lens and a display.

10. A display device, comprising:
a frame defining an aperture;
a lens disposed in the aperture; and
a curtain assembly coupled between the frame and the lens, the curtain assembly comprising:
a taut layer occluding the aperture between the lens and the frame and defining an external surface; and
a slack fabric layer extending between the lens and the frame.

11. The display device of claim 10, wherein:
the lens is a first lens;
the display device further comprises a second lens; and
the curtain assembly comprises:
a middle portion extending between the first lens and the second lens; and
a side portion extending between the first lens and the frame, the first lens disposed between the middle portion and the side portion.

12. The display device of claim 10, wherein the taut layer comprises a woven fabric.

13. The display device of claim 10, further comprising a motor coupled to the lens.

14. The display device of claim 13, wherein:
the frame defines an internal volume;
the display device further comprises an optical assembly disposed in the internal volume, the optical assembly comprising:
the lens; and
a display screen; and
the motor is configured to adjust a position of the lens relative to the frame.

15. The display device of claim 14, wherein the taut layer extends between the lens and the frame in tension.

16. A wearable electronic display device, comprising:
a frame;
an optical lens adjustably coupled to the frame; and
a curtain assembly coupled between the frame and the optical lens, the curtain assembly comprising:
a first layer extending between the frame and the optical lens in tension, the first layer having a first surface area; and
a second layer extending between the frame and the optical lens, the second layer having a second surface area greater than the first surface area.

17. The wearable electronic display device of claim 16, wherein:
the frame defines an aperture; and
the wearable electronic display device further comprises an optical assembly disposed in the aperture, the optical assembly comprising:
the optical lens; and
a display screen.

18. The wearable electronic display device of claim 17, wherein the curtain assembly occludes the aperture between the optical lens and the frame.

19. The wearable electronic display device of claim 16, wherein:
the first layer comprises a first woven fabric; and
the second layer comprises a second woven fabric.

20. The wearable electronic display device of claim 16, wherein:
the curtain assembly includes a perimeter edge coupled to the frame;
the curtain assembly includes an inner edge coupled to the optical lens; and
the first layer and the second layer are free of affixation to one another between the perimeter edge and the inner edge.
